(19) United States
(12) Patent Application Publication
(10) Pub. No.: US 2026/0175787 A1
(43) Pub. Date: Jun. 25, 2026

(54) SUPPORT ARRANGEMENT FOR THE REMOVABLE ATTACHMENT OF AN ADDITIONAL UNIT TO A SUPPORT REGION OF A CONSTRUCTION MACHINE

(71) Applicant: Hamm AG, Tirschenreuth (DE)

(72) Inventor: Gernot REIF, Erlangen (DE)

(21) Appl. No.: 19/423,058

(22) Filed: Dec. 17, 2025

(30) Foreign Application Priority Data
Dec. 20, 2024 (DE) 10 2024 139 158.8

(51) Int. Cl. B60R 11/02; B60R 11/00; E01C 19/26

(52) U.S. Cl. CPC B60R 11/0258; E01C 19/26; B60R 2011/004; E01C 2301/30

(57) ABSTRACT

A support arrangement for the removable attachment of an additional unit to a support region of a construction machine includes a first support assembly to be fixedly attached to the support region of the construction machine, a second support assembly pivotable about a pivot axis and displaceable in a displacement direction on the first support assembly for movement between an additional unit operating position and an additional unit mounting position, and a coupling assembly for removably coupling an additional unit to the second support assembly on a support body of the second support assembly.

The present invention relates to a support arrangement by means of which an additional unit, such as a GPS receiver, can be removably attached to a support region, in particular a roof region, of a construction machine, for example a self-propelled ground compactor.

Additional units, such as GPS receivers, are often mounted on the roof region of, for example, an operating station of a construction machine to ensure good reception of radio signals and also to protect them from damage. In order to subsequently attach such additional units or to remove them from the roof region, for example to carry out repair or maintenance work or to protect against theft, it is generally necessary to gain access to the roof region via a ladder and to remove the additional unit from the roof region, for example by loosening a screw connection or the like.

It is the object of the present invention to provide a support arrangement for the removable attachment of an additional unit, in particular a GPS receiver, to a support region, such as the roof region, of a construction machine, with which the process of attaching and removing the additional unit can be carried out easily while at the same time reliably coupling the additional unit to the roof region.

According to the invention, this object is achieved by a support arrangement for the removable attachment of an additional unit, in particular a GPS receiver, to a support region, in particular a roof region, of a construction machine, comprising:
a first support assembly to be fixedly attached to a support region of a construction machine,
a second support assembly supported on the first support assembly for movement between an additional unit operating position and an additional unit mounting position, such as to be pivotable about a pivot axis and displaceable in a displacement direction,
on a support body of the second support assembly, a coupling assembly for removably coupling an additional unit to the second support assembly.

In the support arrangement according to the invention, the interaction of the two support assemblies makes it possible, on the one hand, to protect the additional unit supported on the second support assembly against unauthorized removal while maintaining a stable mounting when the second support assembly is positioned in the additional unit operating position. By transferring the second support assembly into the additional unit mounting position, access to the additional unit can be obtained such that it can be easily removed from or attached to the second support assembly.

In order to be able to achieve the movement of the second support assembly between the additional unit operating position and the additional unit mounting position in a simple manner, it is proposed that the second support assembly be connected to the first support assembly by means of a pivoting-displacement connection so that it can pivot about the pivot axis and can be displaced in the displacement direction, wherein the pivoting-displacement connection comprises:
on the first support assembly, two displacement rails arranged at a distance from one another substantially orthogonally to the displacement direction,
on the second support assembly, in association with each displacement rail, a rail engagement member which can be displaced along the associated displacement rail in the displacement direction.

In this case, for an interaction between the two support assemblies allowing the required relative mobility between the two support assemblies, each displacement rail can have a displacement opening elongated in the displacement direction, and each rail engagement member can comprise a displacement projection engaging in the displacement opening of the associated displacement rail and displaceable along the displacement opening in the displacement direction.

In order to achieve the pivoting required for transferring between the additional unit operating position and the additional unit mounting position, each displacement projection can be pivotable about a pivot axis in the associated displacement opening.

In an alternative embodiment in which, due to structural specifications, the rail engagement members are only displaceable along the rails but not rotatable or pivotable relative to them, the support body of the second support assembly can be pivotable about a pivot axis relative to each rail engagement member in order to allow the required pivoting.

In order to protect the two support assemblies against unwanted movement relative to each other, it is proposed that a locking device be provided for locking the second support assembly in the additional unit operating position against pivoting and displacement relative to the first support assembly.

The locking device may, for example, comprise:
on a support assembly of the first support assembly and the second support assembly, preferably the first support assembly, at least one locking recess,
on the other support assembly of the first support assembly and the second support assembly, preferably the second support assembly, in association with each locking recess, a respective locking member which is preloaded into a locking position and movable against the preload from the locking position into an unlocking position,
wherein, when the second support assembly is positioned in the additional unit operating position and the locking member is positioned in the locking position, the locking member is blocked against movement out of the locking recess, and wherein, when the second support assembly is positioned in the additional unit operating position and the locking member is positioned in the unlocking position, the locking member is released for movement out of the locking recess.

To obtain a stable locking interaction, it is proposed that:
each locking recess has a locking recess entry region with a first locking recess transverse dimension and a locking recess receiving region adjoining the locking recess entry region with a second locking recess transverse dimension, wherein the second locking recess transverse dimension is greater than the first locking recess transverse dimension,
each locking member has a locking member locking section with a first locking member transverse dimension and a locking member unlocking section with a second locking member transverse dimension, wherein the second locking member transverse dimension is smaller than the first locking recess transverse dimension and the first locking member transverse dimension is greater than the first locking recess transverse dimension and smaller than the second locking recess transverse dimension,
when the second support assembly is positioned in the additional unit operating position, each locking member in the unlocking position is aligned with the associated locking recess such that the locking member unlocking section can be moved through the locking recess entry region, and
when the second support assembly is positioned in the additional unit operating position, each locking member in the unlocking position is aligned with the associated locking recess such that the locking member locking section is positioned in the locking recess receiving region.

Furthermore, for a stable locking interaction, it can be provided that a locking recess which is open substantially transversely to the displacement direction is provided on each displacement rail in the displacement direction at a distance from the displacement opening, and that a locking rod which provides the locking members associated with the locking recesses on the displacement rails is provided on the second support assembly.

The locking position rod can be displaceable for movement between the locking position and the unlocking position substantially transversely to the displacement direction.

For a stable, yet removable coupling of an additional unit to the second support assembly, it is proposed that the coupling assembly comprises a first coupling formation on the second support assembly and a second coupling formation on the additional unit that can be brought into coupling engagement with the first coupling formation, and that a coupling formation of the first coupling formation and the second coupling formation, preferably the second coupling formation, comprises a blocking/releasing member for blocking the one coupling formation against decoupling from the other coupling formation and for releasing the one coupling formation for decoupling from the other coupling formation.

The stable coupling of an additional unit can be further supported in that the first coupling formation comprises two coupling members arranged at a distance from one another, preferably in the displacement direction, and in that the second coupling formation comprises, in association with each coupling member, at least one counter-coupling member which can be brought into and out of coupling engagement with the latter.

In order to be able to establish or interrupt the coupling state with simple measures, one of the counter-coupling members can be pivotally supported on the associated coupling member for coupling the additional unit to the second support assembly and for uncoupling the additional unit from the second support assembly, and the blocking/releasing member can interact with the other coupling member for blocking the one coupling formation against decoupling from the other coupling formation.

In order to prevent the additional unit from becoming accidentally detached from the second support assembly, for example also when vibrations occur, the blocking/releasing member can be blocked against movement to release the one coupling formation for decoupling from the other coupling formation when the additional unit is coupled to the second support assembly and the second support assembly is positioned in the additional unit operating position.

In order to produce this blocking effect only when this is actually necessary, i.e. when the second support assembly with the additional unit supported thereon is in the additional unit operating position, it is proposed that a first blocking member is provided on the first support assembly to block the movement of the blocking/releasing member.

The present invention further relates to a construction machine, in particular a ground compactor, comprising a support region, preferably a roof region provided in association with an operating station, and a support arrangement constructed according to the invention on the support region.

For easy access to an additional unit or the support arrangement, the support region can be a roof region and comprise a roof hatch that can be closed by a closing flap in the displacement direction adjacent to the first support assembly, so that when the second support assembly is positioned in the additional unit operating position, the second support assembly is not positioned overlying the roof hatch and when the second support assembly is positioned in the additional unit mounting position, the second support assembly is partially positioned overlying the roof hatch.

To further secure an additional unit against unauthorized manipulation, it can be provided that the closing flap is movable between a closed position closing the roof hatch and an open position releasing the roof hatch, and that when the closing flap is positioned in the closed position and the second support assembly is positioned in the additional unit operating position, the second support assembly is blocked by the closing flap against movement into the additional unit mounting position.

For this purpose, a second blocking member can be provided on the closing flap, wherein when the closing flap is positioned in the closed position and the second support assembly is positioned in the additional unit operating position, the second support assembly is blocked against pivoting by the second blocking member.

The additional unit can, for example, comprise a GPS receiver. In this context, it should be noted that such a GPS receiver within the meaning of the present invention is any device designed to communicate with a satellite-based or a terrestrial communication system and configured to receive corresponding signals.

The present invention is described in detail below with reference to the attached figures. In particular:

FIG. 1 shows a side view of a construction machine designed as a ground compactor;

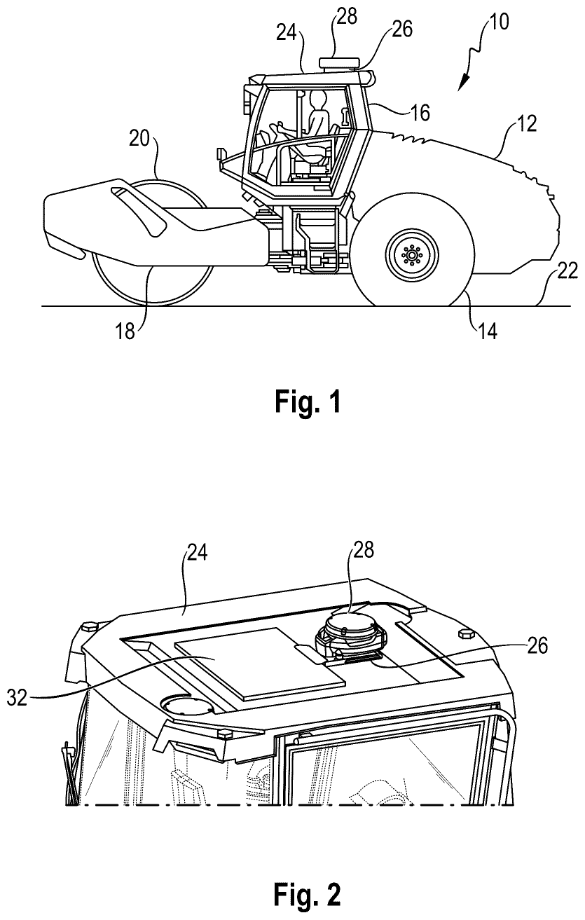

FIG. 2 shows a roof region of an operating station with an additional unit attached to it and a closed roof hatch;

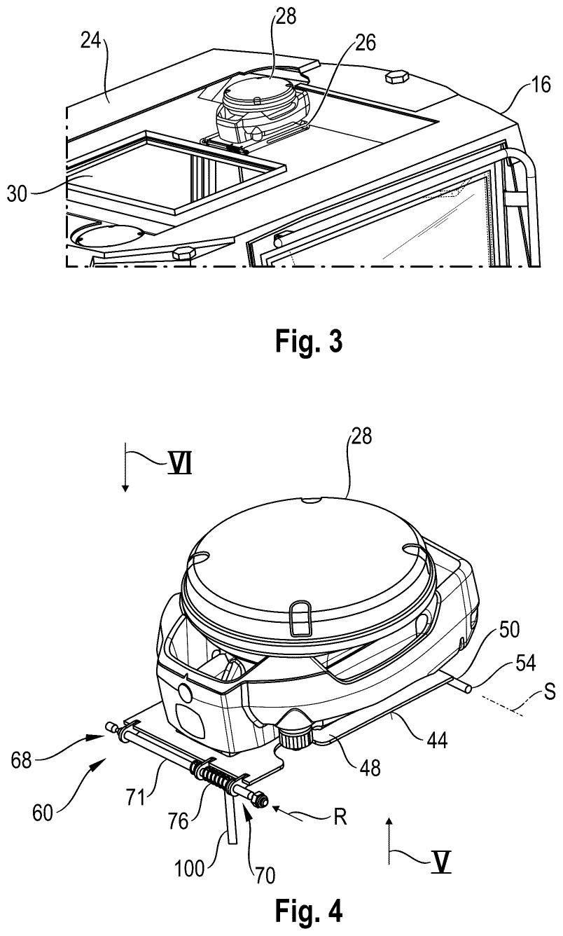

FIG. 3 shows the roof region of FIG. 2 with open roof hatch,

FIG. 4 shows the additional unit coupled to a second support assembly of a support arrangement;

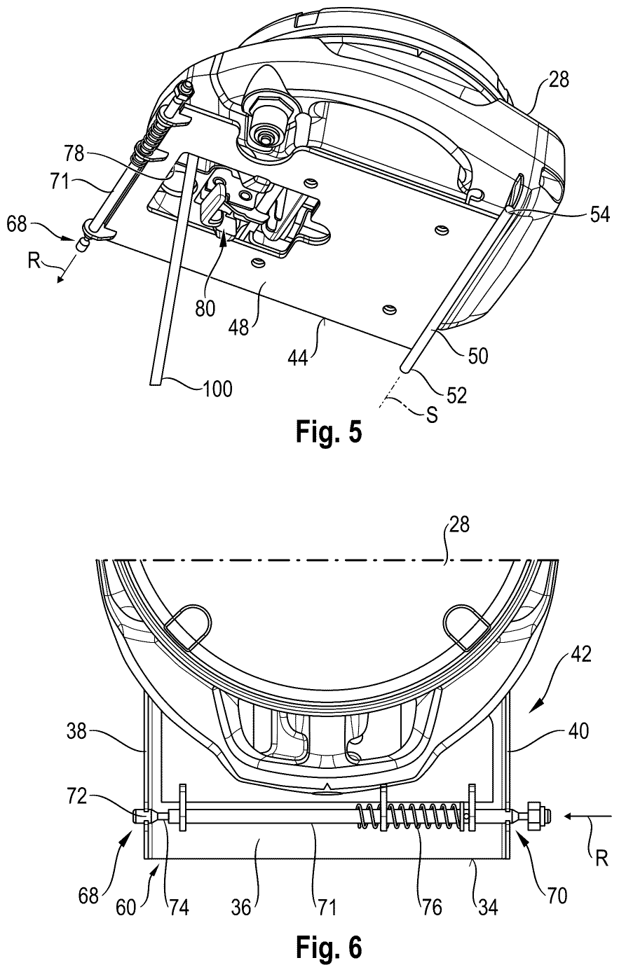

FIG. 5 shows the additional unit of FIG. 4 in viewing direction V in FIG. 4;

FIG. 6 shows the additional unit of FIG. 4 in the viewing direction VI in FIG. 4 with a first support assembly connected to the second support assembly;

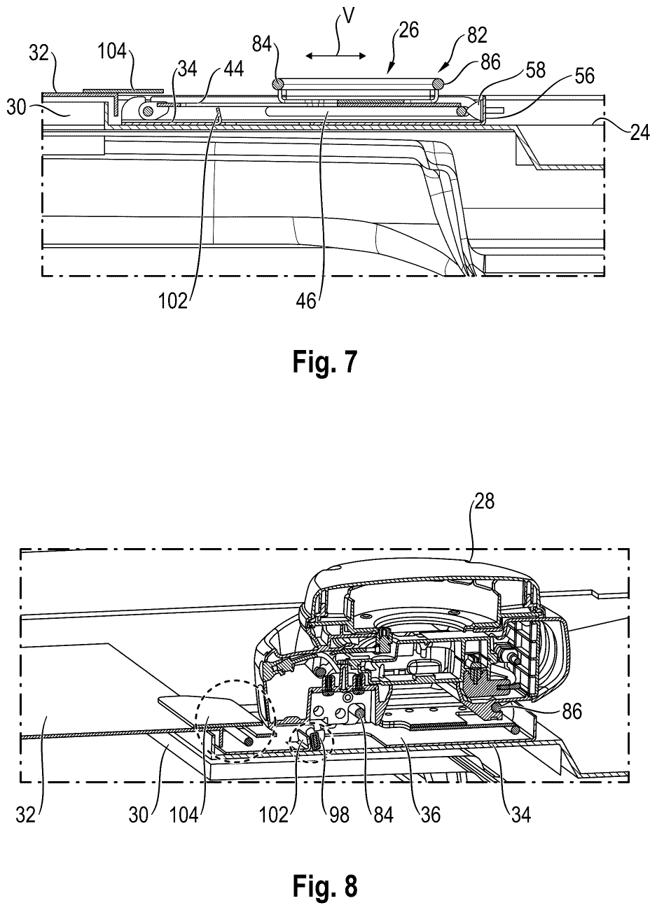

FIG. 7 shows a longitudinal sectional view of the support arrangement used to attach the additional unit to the roof region;

FIG. 8 shows a longitudinal sectional view of the additional unit attached to the roof region by means of the support arrangement of FIG. 7 in a perspective view with the roof hatch closed and in an additional unit operating position of the second support assembly;

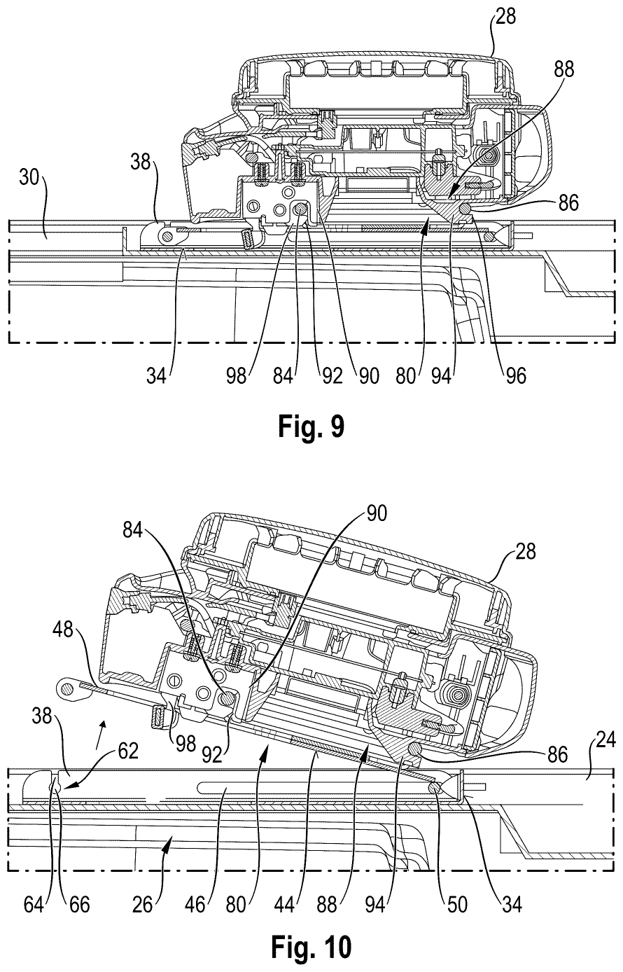

FIG. 9 shows a longitudinal sectional view of the additional unit attached to the roof region by means of the support arrangement with the roof hatch open;

FIG. 10 shows a longitudinal sectional view corresponding to FIG. 9 with a second support assembly pivoted relative to a first support assembly with an additional unit coupled thereto;

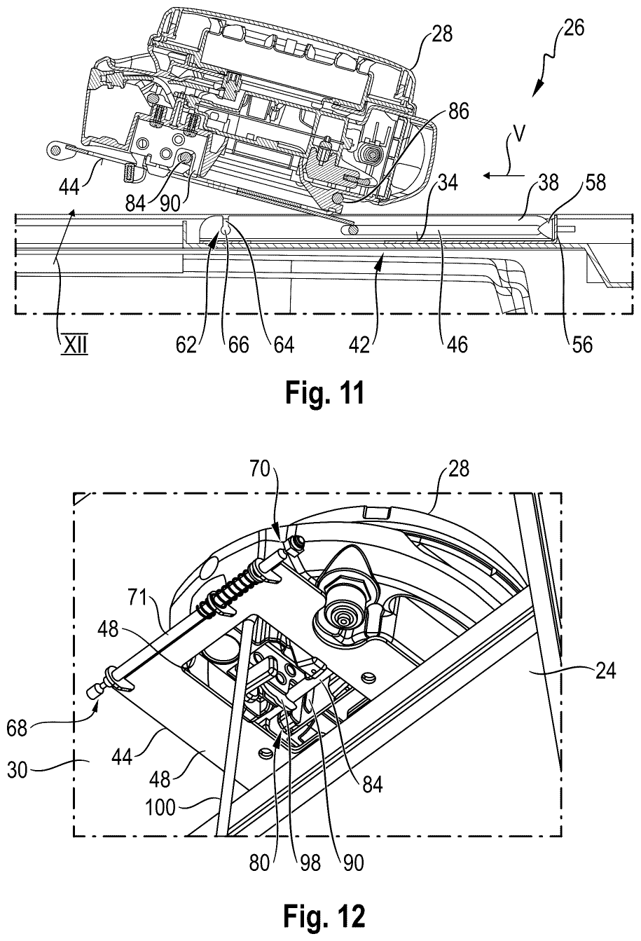

FIG. 11 shows a view corresponding to FIG. 10 with the second support assembly with the additional unit coupled thereto pivoted and displaced into an additional unit mounting position with respect to the first support assembly;

FIG. 12 shows the second support assembly with the additional unit coupled to it, viewed in direction XII in FIG. 11 through the roof hatch.

FIG. 1 shows a side view of a construction machine 10 designed as a ground compactor. The construction machine 10 comprises drive wheels 14 driven by a drive unit and an operating station 16 on a rear carriage 12. A compactor roller 20 is rotatably supported about a roller rotation axis on a front carriage 18 pivotally connected to the rear carriage 12 for steering the construction machine 10. By moving the construction machine 10 or the ground compactor over a ground surface 22, for example asphalt material, the ground surface 22 is compacted.

An additional unit 28, designed, for example, as a GPS receiver, is supported on a roof region 24 of the operating station 16 by means of a support arrangement 26 in such a way that it can be removed from the roof region 24 or attached to it in the manner described below.

FIGS. 2 and 3 show the roof region 24 of the operating station 16 with the additional unit 28 supported thereon. On the roof region 24, immediately adjacent to the additional unit 28 or the support arrangement 26 attached to the roof region 24, a roof hatch 30 is provided, which, as shown in FIG. 2, can be closed by a closing flap 32. For example, the closing flap 32 can be pivoted or displaced to open the roof hatch 30.

The support arrangement 26 provided for the removable attachment of the additional unit 28 to the roof region 24 comprises a first support assembly 34 fixed to the roof region 24, for example by screwing, welding or the like. The first support assembly 34 comprises a support body 36, designed, for example, as a formed sheet metal part, which is bent at its two lateral edge regions to provide two displacement rails 38, 40. Each of the two displacement rails 38, 40 provides a region of a pivoting-displacement connection, generally designated 42, by means of which the first support assembly 34 is connected to a second support assembly 44, which can be seen, for example, in FIG. 5, which is displaceable in a displacement direction V and can be pivoted about a pivot axis S.

In each displacement rail 38, 40, a displacement opening 46 elongated in the displacement direction V is formed. A displacement rod 50 extending substantially transversely to the displacement direction V, i.e. substantially orthogonally thereto, is fixed to a plate-like support body 48 of the second support assembly 44, which provides with its two end regions in association with each displacement rail 38, 40 or the displacement opening 46 provided therein a rail engagement member 52, 54 in the form of a respective displacement projection engaging therein. Each rail engagement member 52, 54 can be moved back and forth in the displacement direction V in the associated displacement opening 46. At the same time, each rail engagement member 52, 54 is pivotable about the pivot axis S in the associated displacement opening 46, so that in principle in each displacement position of the second support assembly 44 with respect to the first support assembly 34, the second support assembly 44 is pivotable about the pivot axis S with respect to the first support assembly 44.

At least one elastic stop 58, for example constructed from rubber material or the like, can be provided on a bent edge region 56 of the support body 36 of the first support assembly 34 extending between the two displacement rails 38, 40, against which stop the second support assembly 44 rests, for example by means of the displacement rod 50, when the second support assembly 44 is positioned in an additional assembly operating position.

In order to be able to lock the second support assembly 44 in the additional unit operating position, which can be seen for example in FIGS. 4 and 8, against movement with respect to the first support assembly 34, a locking device generally designated 60 is provided. This comprises a locking recess 62 on the first support assembly 34 in each of the guide rails 38, 40 in the displacement direction V at a distance from the respective displacement opening 46. The locking recess 62 is open essentially transversely to the displacement direction V away from the support body 36 of the first support assembly 34 and thus extends essentially transversely or essentially orthogonally to the displacement direction V or to the respectively associated displacement opening 46.

Each locking recess 62 comprises a locking recess entry region 64, over which the locking recess 62 is open, and comprises a locking recess receiving region 66, in which a respective locking member 68, 70 is received when the second support assembly 44 is positioned in the additional unit operating position and the locking state is established. Each of the two locking members 68, 70 provided in association with a respective locking recess 62 is formed on a locking rod 71 displaceably supported on the support body 48 of the second support assembly 44 essentially transversely or essentially orthogonally to the displacement direction V in a locking direction R and comprises a locking member locking section 72 and, adjoining thereto, a locking member unlocking section 74.

FIGS. 10 and 11 show that for each locking recess 62, the locking recess entry region 64 has a first locking recess transverse dimension, i.e. a dimension substantially transverse to the locking direction R and in the displacement direction V, which is smaller than a second locking recess transverse dimension in the region of the respective locking recess receiving region 66.

FIG. 6 shows that for each locking member 68, 70, the respective locking member locking section 72 has a first locking member transverse dimension, in particular diameter, which is greater than a second locking member transverse dimension in the respective locking member unlocking section 74. The second locking member transverse dimension is further smaller than the first locking recess transverse dimension, so that the locking rod 71, when positioned in an unlocking position in the locking direction R with the locking member unlocking sections 74 of the two locking members 68, 70, can pass through the locking recess entry regions 64 of the associated locking recesses 62.

When the second support assembly 44 is positioned in the additional unit operating position and the locking rod 71 is positioned in a locking position in the locking direction R, the locking member locking sections 72 lie in the associated locking recess receiving regions 66 and cannot be moved out of the locking recesses 62 by pivoting the second support assembly 44 about the pivot axis S due to the fact that the first locking member transverse dimension is greater than the first locking recess transverse dimension.

For this purpose, it is first necessary that the locking rod 71 is displaced from the locking position into the unlocking position against the preloading action of a preloading spring 76 in the locking direction R with respect to the support body 48 of the second support assembly 44 to such an extent that the respective locking member unlocking sections 64 are aligned with the locking recesses 62 in the locking direction R, so that the locking rod 71 can then basically be moved out of the locking recesses 62 or the second support assembly 44 can be pivoted into a position shown in FIG. 10, in which an end region of the support body 48 of the second support assembly 44, which also supports the locking rod 71, is pivoted upwards and away from the first support assembly 44.

Furthermore, when the second support assembly 44 is positioned in the additional unit mounting position, the second support assembly 44 is preloaded in the displacement direction V with respect to the first support assembly 34 in the direction of the roof hatch 30 by the at least one elastic stop 58 such that the locking rod 71 with the locking member locking sections 72 of the locking members 68, 70 is preloaded against the displacement rails 38, 40 in their sections delimiting the locking recess receiving regions 66. The occurrence of rattling noises due to a fundamentally unavoidable movement play of the locking member locking sections 72 in the locking recess receiving regions 66 can thus be avoided.

Starting from this positioning and coming from the additional unit operating position also shown in FIG. 9, the second support assembly 44 with the additional unit 28 coupled to it can subsequently be moved in the displacement direction V towards the roof hatch 30 into an additional unit mounting position. While in the additional unit operating position or in the upwardly pivoted position shown in FIG. 10, the additional unit 28 or the second support assembly 44 is displaced away from the region of the roof hatch 30 and thus does not cover the roof hatch 30, in the additional unit mounting position shown in FIG. 11, the second support assembly 44 or the additional unit 28 is positioned such that the roof hatch 30 is partially covered and thus there is access in particular to an opening 78 formed in the support body 48 of the second support assembly 44.

A coupling assembly generally designated 80 is provided for removably coupling the additional unit 28 to the second support assembly 44. The coupling assembly 80 comprises on the second support assembly 44 a first coupling formation 82 with two coupling members 84, 86, which are positioned at a distance from one another in the displacement direction V and are, for example, rod-like and extend substantially transversely to the displacement direction V. In association with the first coupling formation 82, a second coupling formation 88 is provided on the additional unit 28. This comprises, in association with the coupling member 84 of the first coupling formation 28, a counter-coupling member 90 with a coupling recess 92 open downwards, i.e. towards the second support assembly.

The second coupling formation 88 comprises, in association with the other coupling member 86 of the first coupling formation 80, for example, two hook-like counter-coupling members 94 positioned at a distance from one another transversely to the displacement direction V. Each counter-coupling member 94 has a coupling recess 96 which, when the second support assembly 44 is not pivoted in position with respect to the first support assembly 34, is open substantially in the displacement direction V in the direction away from the other counter-coupling member 90.

When the coupling member 86 is received in the coupling recesses 96 of the counter-coupling members 94, the additional unit 28 can in principle be pivoted with respect to the second support assembly 44 about an axis substantially parallel to the pivot axis S. When the additional unit 28 is coupled to the second support assembly 44, the coupling member 84 is also received in the associated coupling recess 92 of the counter-coupling member 90. By means of a blocking/releasing member 98, which is pivotably supported, for example, on the counter-coupling member 90, when the coupling member 84 is received in the coupling recess 92, the additional unit 28 is coupled to the two coupling members 84, 86 and thus to the second support assembly 44 and is blocked against detachment by the blocking/releasing member 98. By pivoting the blocking/releasing member 98, for example against the return action of a preload spring from the blocking position shown in FIG. 10 in a clockwise direction into a release position, the coupling member 84 is released so that the counter-coupling member 90 is moved away from the coupling member 84 and the additional unit 28 can be pivoted accordingly about the coupling member 86. After sufficient pivoting, the additional unit 28 can then also be pulled away from the coupling member 86 so that it exits the associated coupling recesses 96 and thus the additional unit 28 is decoupled from the second support assembly 44.

To remove the additional unit 28 from the second support assembly 44 or the roof region 24, a connecting cable 100, which is guided, for example, through the opening 78 in the support 48 of the second support assembly 44, can then be removed from a connecting plug provided, for example, on the roof region 24.

In FIG. 8 it can be seen that a first blocking member 102, formed for example by bending, is provided on the support body 36 of the first support assembly 34, by which the blocking/releasing member 98 is blocked against pivoting and thus against release of the coupling member 84 when the second support assembly 44 is positioned in the additional unit operating position. Furthermore, when the second support assembly 44 is positioned in the additional unit operating position and the roof hatch 30 is closed by the closing flap 32, a second blocking member 104 provided on the closing flap 32 is positioned such that it partially overlays the second support assembly 44.

Even if, with the second support assembly 44 positioned in the additional unit operating position and the closing flap 32 positioned in the position closing the roof hatch 30, the locking rod 71 is displaced in the locking direction R into the unlocking position, so that the locking member decoupling sections 74 of the locking members 68, 70 are basically aligned with the associated locking recesses 62 in the displacement rails 38, 40, the second support assembly 44 could not be pivoted in such a way that it could be displaced in the displacement direction V. On the one hand, this displacement would be prevented by the blocking member 102, and on the other hand, the second support assembly 44 could not be brought into a pivoting position about the pivot axis S, which would allow a displacement of the second support assembly 44 into the additional unit mounting position after the blocking effect of the first blocking member 102 is removed. An exit of the locking rod 71 from the locking recesses 62 would be already prevented by the second blocking member 104 which overlaps the second support assembly 44 in the region of the support body 48.

Finally, it should be pointed out that the removable coupling of an additional unit by means of the support arrangement to a construction machine designed according to the invention can also be used with construction machines of a different design or used for other work processes, such as wheel loaders, excavators, road milling machines, asphalt pavers or the like. For example, if an operating station provided on such a construction machine is open, i.e., has no roof, the support arrangement designed according to the invention can also be attached in other regions of such construction machines, for example on a motor hood or another panel region.

1. A support arrangement for the removable attachment of an additional unit to a support region of a construction machine, comprising:
a first support assembly to be fixedly attached to the support region of the construction machine,
a second support assembly supported on the first support assembly for movement between an additional unit operating position and an additional unit mounting position, such as to be pivotable about a pivot axis and displaceable in a displacement direction,
on a support body of the second support assembly, a coupling assembly for removably coupling an additional unit to the second support assembly.

2. The support arrangement according to claim 1,
wherein the second support assembly is connected to the first support assembly by a pivoting-displacement connection so as to be pivotable about the pivot axis and displaceable in the displacement direction, wherein the pivoting-displacement connection comprises:
on the first support assembly, two displacement rails arranged at a distance from one another substantially orthogonally to the displacement direction,
on the second support assembly, in association with each displacement rail, a rail engagement member which can be displaced along the associated displacement rail in the displacement direction.

3. The support arrangement according to claim 2,
wherein each displacement rail has a displacement opening which is elongated in the displacement direction, and each rail engagement member comprises a displacement projection which engages in the displacement opening of the associated displacement rail and is displaceable along the displacement opening in the displacement direction.

4. The support arrangement according to claim 3,
wherein each displacement projection is pivotable about a pivot axis in the associated displacement opening.

5. The support arrangement according to claim 2,
wherein the support body of the second support assembly is pivotable about a pivot axis with respect to each rail engagement member.

6. The support arrangement according to claim 1,
further comprising a locking device provided for locking the second support assembly in the additional unit operating position against pivoting and displacement relative to the first support assembly.

7. The support arrangement according to claim 6,
wherein the locking device comprises:
on a support assembly of the first support assembly and the second support assembly at least one locking recess,
on the other support assembly of the first support assembly and the second support assembly, in association with each locking recess, a respective locking member which is preloaded into a locking position and movable against the preload from the locking position into an unlocking position,
wherein, when the second support assembly (44) is positioned in the additional unit operating position and the locking member is positioned in the locking position, the locking member is blocked against movement out of the locking recess, and wherein, when the second support assembly is positioned in the additional unit operating position and the locking member is positioned in the unlocking position, the locking member is re-leased for movement out of the locking recess.

8. The support arrangement according to claim 7, wherein:
each locking recess has a locking recess entry region with a first locking recess transverse dimension and a locking recess receiving region adjacent to the locking recess entry region with a second locking recess transverse dimension, wherein the second locking recess transverse dimension is greater than the first locking recess transverse dimension,
each locking member comprises a locking member locking section with a first locking member transverse dimension and a locking member unlocking section with a second locking member transverse dimension, wherein the second locking member transverse dimension is smaller than the first locking recess transverse dimension, and the first locking member transverse dimension is larger than the first locking recess transverse dimension and smaller than the second locking recess transverse dimension,
when the second support assembly is positioned in the additional unit operating position, each locking member in the unlocked position is aligned with the associated locking recess in such a way that the locking member unlocking section can be moved through the locking recess entry region, and
when the second support assembly is positioned in the additional unit operating position, each locking member in the locking position is aligned with the associated locking recess such that the locking member locking section is positioned in the locking recess receiving region.

9. The support arrangement according to claim 7,
wherein each displacement rail has a displacement opening which is elongated in the displacement direction, and each rail engagement member comprises a displacement projection which engages in the displacement opening of the associated displacement rail and is displaceable along the displacement opening in the displacement direction
wherein on each displacement rail in the displacement direction at a distance from the displacement opening, a locking recess is provided which is open substantially transversely to the displacement direction and a locking rod is provided on the second support assembly which provides locking members associated with the locking recesses on the displacement rails.

10. The support arrangement according to claim 9,
wherein the locking position rod is displaceable for movement between the locking position and the unlocking position substantially transversely to the displacement direction.

11. The support arrangement according to claim 1,
wherein the coupling assembly comprises a first coupling formation on the second support assembly and a second coupling formation on the additional unit that can be brought into coupling engagement with the first coupling formation, and a coupling formation of the first coupling formation and the second coupling formation comprises a blocking/releasing member for blocking the one coupling formation against decoupling from the other coupling formation and for releasing the one coupling formation for decoupling from the other coupling formation.

12. The support arrangement according to claim 11,
wherein the first coupling formation comprises two coupling members spaced apart from each other,, and the second coupling formation in association with each coupling member comprises at least one counter-coupling member capable of being brought into and out of coupling engagement with the latter.

13. The support arrangement according to claim 12,
wherein for coupling the additional unit to the second support assembly and for decoupling the additional unit from the second support assembly, one of the counter-coupling members is pivotably supported on the associated coupling member, and that the blocking/releasing member cooperates with the other coupling member for blocking the one coupling formation against decoupling from the other coupling formation.

14. The support arrangement according to claim 1,
wherein when the additional unit is coupled to the second support assembly and the second support assembly is positioned in the additional unit operating position, the blocking/releasing mechanism is blocked against movement to release the one coupling formation for decoupling from the other coupling formation.

15. The support arrangement according to claim 14,
wherein a first blocking member is provided on the first support assembly to block the blocking/releasing member against movement.

16. A construction machine comprising a support region provided in association with an operating station, and a support arrangement according to claim 1.

17. The construction machine according to claim 16,
wherein the support region is a roof region and comprises a roof hatch in the displacement direction adjacent to the first support assembly, which can be closed by a closing flap, so that when the second support assembly is positioned in the additional unit operating position, the second support assembly is positioned without over-laying the roof hatch, and when the second support assembly is positioned in the additional unit mounting position, the second support assembly is positioned partially overlaying the roof hatch.

18. The construction machine according to claim 17,
wherein the closing flap is movable between a closed position closing the roof hatch and an open position releasing the roof hatch, and when the closing flap is positioned in the closed position and the second support assembly is positioned in the additional unit operating position, the second support assembly is blocked by the closing flap against movement into the additional unit mounting position.

19. The construction machine according to claim 18,
wherein a second blocking member is provided on the closing flap, wherein, when the closing flap is positioned in the closed position and the second support assembly is positioned in the additional unit operating position, the second support assembly is blocked against pivoting by the second blocking member.

20. The construction machine according to claim 1 wherein the additional unit comprises a GPS receiver.
